(19) United States
(12) Patent Application Publication
(10) Pub. No.: US 2023/0354041 A1
(43) Pub. Date: Nov. 2, 2023

(54) CONCEALED THREE-DIMENSIONAL DATA OBJECT FOR MULTI FACTOR AUTHENTICATION

(71) Applicant: Crestron Electronics, Inc., Rockleigh, NJ (US)

(72) Inventor: Samir Termanini, Little Falls, NJ (US)

(73) Assignee: Crestron Electronics, Inc., Rockleigh, NJ (US)

(21) Appl. No.: 18/198,571

(22) Filed: May 17, 2023

Related U.S. Application Data
(63) Continuation-in-part of application No. 17/891,326, filed on Aug. 19, 2022.

(51) Int. Cl. H04W 12/77; H04W 12/06

(52) U.S. Cl. CPC H04W 12/77; H04W 12/06

(57) ABSTRACT

In some implementations, the device may include a mobile user device having a first side and a second side, the mobile user device having a first wireless communication interface communicatively coupled to a cloud network, an optical imaging camera positioned on the first side of said mobile user device, a first LIDAR camera disposed on the first side, and a display screen disposed on said second side of said mobile user device. In addition, the device may include a conferencing device having an outer enclosure, the conferencing device including a display screen housed within said outer enclosure, a bezel cover that forms a part of the outer enclosure and covers said display screen, where said bezel cover includes an electrochromatic region that is transparent when electrically energized and said electrochromatic region is opaque when de-energized. The device may include a three-dimensional object encoded with a symbology for representing data in the x-direction, y-direction, and z-direction, said three-dimensional object disposed behind said electrochromatic region of said bezel cover and inside the interior of said enclosure. Moreover, the device may include a remote cloud server having a network interface communicatively coupled to said remote cloud server, the remote cloud server having CPU and a nonvolatile storage.

### BACKGROUND OF THE INVENTION

### Technical Field

The present disclosure relates generally to electronic security, and more specifically, to the use of a mobile user device for authenticating and verifying a user's actual presence at a workspace at check-in and applying a predetermined profile for the configuration of hardware resources available to the workspace.

### Description of the Related Art

Organizations are increasingly adopting some form of hybrid hoteling model for its workforce in which workers dynamically schedule their use of onsite rooms. Centralized scheduling of these onsite rooms has traditionally been accomplished using an electronic reservation system having a calendar-based scheduling server to upload and/or download one or more aspects of availability data associated with a room. An electronic reservation system might be used to reserve an office or conference room, with the result being that others can access the reservation system to ascertain whether the room might be available for their own use.

Participants in an organization, that dynamically schedules onsite rooms, may interact with a reservation system using a scheduling device. For example, each room may have a dedicated scheduling device. Examples include scheduling touchscreens offered by Crestron Electronics, Inc. Of Rockleigh, N.J. Touchscreens can be installed outside of a room which can be programed to allow users to view the room availability, check the status of nearby rooms, and/or reserve a room for an ad hoc meeting simply by interacting the touch screen. Interacting with a reservation system can also be accomplished using a mobile user device (e.g., a mobile smartphone) running an approved software application.

Barcodes have become a known and widely accepted method for storing information. Their most popular use includes determining the price of an item at retail check-out counters. Other uses may also include, item identification, detailed part information, serial number information, and inventory information. Commonly encountered barcodes are usually either one-dimensional or two-dimensional and are typically printed directly on an object's surface or on labels affixed to an object's surface. Barcodes are typically read by optical scanning techniques using countertop scanners, handheld wands, or mobile phone cameras. One-dimensional Barcodes typically comprise bars and spaces with bars of varying widths representing strings of binary ones and spaces of varying widths representing binary zeros. An example of a one-dimensional barcode 101 is shown in FIG. 1.

Two-dimensional barcodes have also become a known and widely accepted method for storing information. An example of a two-dimensional barcode is the data matrix code, which consists of black and white “cells” or dots arranged in either a square or rectangular pattern. One example of a two-dimensional barcode is the Quick Response code (QR-code.) A QR-code consists of black squares arranged in a square grid on a white background. Information such as a street address, telephone number, or web browser URL, for example, may be stored in a quick response (QR) code. A QR code may be readable by mobile phones with a camera, smart phones, computing devices, specialized scanners, and so on. The information encoded within the matrix barcode may be text, uniform resource indicator (URI), alphanumeric, numeric, and other data. Users with a camera phone or other mobile user device equipped with the correct reader application can convert a photographic image of the matrix barcode to display text, contact information, connect to a wireless network, open a webpage in the phone's browser, and so on.

Three-dimensional imagers, ubiquitously available on consumer-grade mobile user devices, sometimes known as light detection and ranging (LiDAR) sensors, can be used to capture point depth information of objects or an area by illumination with an optical beam and by analyzing the reflected optical beam. A commonly used technique to determine the distance to each point on the target involves projecting an optical beam towards the target, followed by the measurement of the round-trip time, i.e. Time-of-flight (ToF), taken by the optical beam as it travels from the source to target and back to a detector adjacent to the source. Based on the time elapsed between emission of the pulse of light and detection of the returned pulse of light, a distance is estimated. LiDAR can be used to scan a 3D surface of objects and distinguish it from other objects.

While biometric authentication may be advantageous because it allows a user to authenticate more securely and quickly than, for example, entering a password or some other credential, the same level of biometric security does not currently exist for authenticating a hardware device.

The information included in this Background section of the specification, including any references cited herein and any description or discussion thereof, is included for technical reference purposes only and is not to be regarded subject matter by which the scope of the invention as defined in the claims is to be bound.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A system of one or more computers can be configured to perform operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, workspace management system may include a networked workspace scheduling server. Workspace management system may also include a conferencing device having a three-dimensional authentication object encoded with data that is read using lidar and disposed behind a bezel cover, where the bezel cover has at least two modes, a visible mode and a concealed mode, where when the bezel cover is in a visible mode, the three-dimensional authentication object is visible to a lidar scanner, and when the bezel cover is in a concealed mode, the three-dimensional authentication object is not visible to a lidar scanner. System may furthermore include a mobile user device having an application installed thereon, where the form authentication token associated with the mobile user device and encoded in the three-dimensional authentication object is retrievable by the application. System may in addition include at least one security camera for capturing images of the three-dimensional authentication object on the conferencing device. Other embodiments of this aspect include corresponding computer systems, apparatus, and computer programs recorded on one or more computer storage devices, each configured to perform the actions of the methods.

Implementations may include one or more of the following features. System where when the bezel cover is in the visible mode, the transmission of visible light wavelengths in the range of 400700 nanometers is enabled allow an user interacting with the conferencing device to determine that the three-dimensional authentication object is visible. System where the bezel cover further may include a layer of electrochromic film that become opaque when de-energized and transparent when energized. System where when the bezel cover may include a plurality of independently operable electrochromic shutters arranged over several LIDAR readable three-dimensional objects. 5 where when the application uses the form authentication token associated with the mobile user device encoded in the three-dimensional authentication object to access the workspace scheduling server. Implementations of the described techniques may include hardware, a method or process, or a computer tangible medium.

In one general aspect, method may include encoding data into a three-dimensional authentication object disposed behind a bezel cover of a conferencing device, where the bezel cover has at least two modes, a visible mode and a concealed mode, where when the bezel cover is in a visible mode, the three-dimensional authentication object is visible to a lidar scanner, and when the bezel cover is in a concealed mode, the three-dimensional authentication object is not visible to a lidar scanner. Method may also include capturing an image of the three-dimensional authentication object using at least one security camera. Method may furthermore include retrieving a form authentication token from the captured image. Method may in addition include accessing a networked workspace scheduling server using the form authentication token retrieved from the captured image. Method may moreover include performing additional verification steps based on the information retrieved from the workspace scheduling server. Other embodiments of this aspect include corresponding computer systems, apparatus, and computer programs recorded on one or more computer storage devices, each configured to perform the actions of the methods.

Implementations may include one or more of the following features. Method where when the bezel cover is in the visible mode, the transmission of visible light is enabled allow an user interacting with the conferencing device to determine that the three-dimensional authentication object is visible. Method where the form authentication token is retrieved by an application installed on a mobile user device and utilizes the form authentication token associated with said mobile user device. Method where the bezel cover further may include a layer of electrochromic film that become opaque when de-energized and transparent when energized. Method where when the bezel cover may include a plurality of independently operable electrochromic shutters arranged over several LIDAR readable three-dimensional objects. Implementations of the described techniques may include hardware, a method or process, or a computer tangible medium.

In one general aspect, workspace management system may include A mobile user device. Workspace management system may also include A remote cloud server communicatively coupled with said mobile user device, said remote cloud server adapted to interface with one or more electronically controlled devices disposed in a workspace. System may furthermore include An authentication engine, stored in a nonvolatile storage and communicatively coupled with the remote cloud server over a cloud network, said authentication engine being adapted to receive input data from the mobile user device having a three-dimensional data object including physical parameters by which an user is authenticated. Other embodiments of this aspect include corresponding computer systems, apparatus, and computer programs recorded on one or more computer storage devices, each configured to perform the actions of the methods.

Implementations may include one or more of the following features. Workspace management system where said three-dimensional data object is captured by a camera of said mobile user device. Workspace management system where said three-dimensional data object includes biometric characteristics of an user. Workspace management system may include a database, where said authentication engine is adapted to compare said input data with stored biometric information of said user. Workspace management system where said three-dimensional data object includes facial recognition patterns associated with an user. Workspace management system may include a control system processor adapted to act as an intermediary between said remotely cloud server and the electronically controlled devices. Workspace management system where said remotely cloud server is adapted to receive data directly from the electronically controlled devices. Workspace management system where said workspace management system is customized according to user requirements. Implementations of the described techniques may include hardware, a method or process, or a computer tangible medium.

In one general aspect, method may include Receiving input data from a mobile user device, said input data having a three-dimensional data object including physical parameters by which an user can be authenticated. Method may also include Transmitting said input data from said mobile user device to a remote cloud server over a cloud network. Method may furthermore include Comparing said input data received from said mobile user device with stored biometric information associated with said user. Method may in addition include Authenticating said user if said input data matches said stored biometric information. Other embodiments of this aspect include corresponding computer systems, apparatus, and computer programs recorded on one or more computer storage devices, each configured to perform the actions of the methods.

Implementations may include one or more of the following features. Method where said three-dimensional data object is captured by a camera of said mobile user device. Method where said three-dimensional data object includes biometric characteristics of an user. Method where said input data is transmitted by said mobile user device via an Uniform Resource Locator (URL) decoded from a QR-Code. Method may include controlling one or more electronically controlled devices disposed in a workspace based on the authentication of said user. Implementations of the described techniques may include hardware, a method or process, or a computer tangible medium.

In one general aspect, workspace management system may include a remote cloud server having a CPU, a main memory and a nonvolatile storage. Workspace management system may also include the nonvolatile storage having workspace automation application. System may furthermore include a plurality of controllable electronic devices associated with said workspace management system. System may in addition include one or more mobile user devices adapted to access said remote cloud server. System may moreover include an authentication engine operably associated with said main memory and said CPU, where said authentication engine is adapted to authenticate users using said mobile user device. Other embodiments of this aspect include corresponding computer systems, apparatus, and computer programs recorded on one or more computer storage devices, each configured to perform the actions of the methods.

Implementations may include one or more of the following features. System may include control system processor connected to said electronic devices; and where said control system processor may include web interface to communicate with said remote cloud server. System where said authentication engine stores data and logic steps necessary to authenticate users using said mobile user device. System where said authentication engine may include multifactor authentication capabilities, which may include Three-dimensional data objects for various authentications. Implementations of the described techniques may include hardware, a method or process, or a computer tangible medium.

In one general aspect, method may include providing a workspace management system, having remote cloud server, one or more mobile user devices, a plurality of controllable electronic devices associated with said workspace management system, an authentication engine. Method may also include receiving user input at said mobile user device. Method may furthermore include authenticating user using said authentication engine. Method may in addition include receiving command data from said authenticated user at said remote cloud server. Method may moreover include forwarding said command data to said electronic devices. Method may also include controlling one or more said electronic devices in response to said command data. Other embodiments of this aspect include corresponding computer systems, apparatus, and computer programs recorded on one or more computer storage devices, each configured to perform the actions of the methods.

Implementations may include one or more of the following features. Method where said authenticating said user may include verifying user credentials using user input. Method where said verification step may include performing multifactor authentication of user credentials, where said authentication may include three-dimensional data objects. Method where said authenticating step further may include biometric authentication of user credentials. Implementations of the described techniques may include hardware, a method or process, or a computer tangible medium.

In one general aspect, workspace management system may include a conferencing device having: Workspace management system may also include a video camera, a microphone, a display screen, a bezel adapted to conceal a LIDAR readable three-dimensional data object, the bezel being electrochromic and being controllable between at least two states of transparency such that in one state at least a portion of the object is visible to a LIDAR scanner, and in another state the entire object is concealed. System may furthermore include a workspace scheduling server communicatively coupled to the conferencing device and adapted to generate, manage, store, and transmit tokenized URLs over a network to the conferencing device to enable an user to initiate an authentication process where, upon receipt of the tokenized URL, the conferencing device selectively controls the bezel's opacity to prevent the scanning of the adjacent LIDAR readable three-dimensional object until the user has completed a specified preliminary user check-in. Other embodiments of this aspect include corresponding computer systems, apparatus, and computer programs recorded on one or more computer storage devices, each configured to perform the actions of the methods.

Implementations may include one or more of the following features. System where the specified preliminary user check-in may include having the user point their user communication device camera at a QR-Code currently displayed on the display screen of the conferencing device. System where the QR-Code is encoded with a tokenized URL that points to a link for downloading an application from the user communication device's authorized App store. System where the tokenized URL downloads and installs the application, uses login credentials from the encoded information in order to complete the preliminary user check-in. System where the bezel is adapted to include more than one uniquely encoded LIDAR readable three-dimensional object disposed in different areas behind the bezel and the conferencing device bezel is adapted to reveal only one of the LIDAR readable three-dimensional objects according to a programmed sequence for any authentication logic. Implementations of the described techniques may include hardware, a method or process, or a computer tangible medium.

In one general aspect, workspace management system may include a conferencing device. Workspace management system may also include a three-dimensional authentication object encoded with additional information. System may furthermore include a bezel cover adapted to selectively conceal the three-dimensional authentication object. System may in addition include an electrochromic material coupled between the bezel cover and the three-dimensional authentication object, where the electrochromic material is adapted to vary the opacity of the bezel cover. System may moreover include an optical scanner in communicative connection with the conferencing device for scanning the three-dimensional authentication object when the bezel cover is in an opaque state and the additional information is successfully read. Other embodiments of this aspect include corresponding computer systems, apparatus, and computer programs recorded on one or more computer storage devices, each configured to perform the actions of the methods.

Implementations may include one or more of the following features. Workspace management system where the electrochromic material responds to electrical signals from the conferencing device for varying the opacity of the bezel cover. Workspace management system may include a processor adapted to compare information obtained by scanning the three-dimensional authentication object to predetermined information stored on the conferencing device and associated with the conferencing device. Implementations of the described techniques may include hardware, a method or process, or a computer tangible medium.

In one general aspect, method may include providing a conferencing device having an embedded system. Method may also include encoding a three-dimensional object with additional information. Method may furthermore include disposing the three-dimensional object beneath an electrochromic bezel cover coupled to the conferencing device. Method may in addition include displaying a QR-code on the conferencing device. Method may moreover include receiving additional authorization information via a mobile user communication device that scans the displayed QR-code and transmits the received additional information to a networked workspace scheduling server. Method may also include utilizing the information transmitted to the networked workspace scheduling server to initiate an additional authentication workflow if necessary. Method may furthermore include progressively varying the opacity of the electrochromic bezel cover to reveal the three-dimensional object. Method may in addition include scanning the revealed three-dimensional object using an optical scanner in communicative connection with the conferencing device to obtain the additional information associated with the three-dimensional object. Other embodiments of this aspect include corresponding computer systems, apparatus, and computer programs recorded on one or more computer storage devices, each configured to perform the actions of the methods.

In one general aspect, method may include obtaining a three-dimensional object encoded with four distinct symbols indicative of an authentication for configurable workspaces, the symbols being encoded in the height of each cuboid. Method may also include placing the three-dimensional object in a conference device having a bezel cover adapted to selectively conceal or reveal the object based on an user's request. Method may furthermore include scanning the object using a LIDAR camera to detect the symbols. Method may in addition include verifying the authenticity of the symbols by comparing them to a predetermined set of symbols. Other embodiments of this aspect include corresponding computer systems, apparatus, and computer programs recorded on one or more computer storage devices, each configured to perform the actions of the methods.

Implementations may include one or more of the following features. Method where the symbols are different numerical values. Method including: generating a tokenized URL from a networked workspace scheduling server; displaying the tokenized URL via a QR-code displayed on the display screen of the conferencing device; providing access to a mobile application by downloading and installing the new application corresponding to the tokenized URL via a mobile user device camera; transmitting the authentication token associated with the QR-code from the mobile user device to the networked workspace scheduling server; and prompting the networked workspace scheduling server to initiate additional authentication steps. Method where the additional authentication steps include verifying the authenticated token is authorized for use of the respective conference device. Implementations of the described techniques may include hardware, a method or process, or a computer tangible medium.

In one general aspect, system may include a plurality of three-dimensionally encoded tokens configured plurality of conference devices. System may also include a networked workplace scheduling server adapted to generate, manage, store, and transmit the tokens to the conference device. System may furthermore include receive authentication tokens from remote user devices. Other embodiments of this aspect include corresponding computer systems, apparatus, and computer programs recorded on one or more computer storage devices, each configured to perform the actions of the methods.

Implementations may include one or more of the following features. System where said plurality of conference devices may include: a video camera; a microphone; a display screen that may be a 10 high resolution touch screen; and a bezel configured with at least two modes to be transparent or substantially opaque, the plurality further configured with a three-dimensional authentication object having a LIDAR readable object disposed behind the bezel, where the LIDAR readable object is encoded with additional information that can be used for an additional authentication workflow. Implementations of the described techniques may include hardware, a method or process, or a computer tangible medium.

In one general aspect, method may include scanning a three-dimensional object behind an electrically energized cover with at least one LIDAR camera of a wireless device to capture data encoded in the three-dimensional object. Method may also include transmitting the captured data to a remote cloud server. Method may furthermore include authenticating the transmitted data by comparing it with stored authentication information associated with said three-dimensional object. Method may in addition include upon successful authentication, sending instructions to said electrically energized cover of a conference device to de-energize. Other embodiments of this aspect include corresponding computer systems, apparatus, and computer programs recorded on one or more computer storage devices, each configured to perform the actions of the methods.

Implementations may include one or more of the following features. Method where said three-dimensional object is encoded with a symbology for representing data in the x direction, y direction, and z direction. Method may include: generating an authentication token on a remote cloud server; encoding said authentication token in a QR code for display on a display screen portion of said conference device; transmitting instructions from said remote cloud server to energize an electrochromic region disposed within an outer enclosure that houses at least one display screen portion of the conference device; and when displaying QR code containing encoded information associated with authenticating user credentials and access privileges associated with workspace management system. Implementations of the described techniques may include hardware, a method or process, or a computer tangible medium.

In one general aspect, method may include receiving, by a workspace management system from a mobile user device having an optical imaging camera and first LIDAR camera disposed on the same side of said mobile user device, data containing information captured by said optical imaging camera and said first LIDAR camera. Method may also include authenticating, by the workspace management system using at least one three-dimensional object encoded with symbology for representing data in x, y, z directions that is disposed behind an electrochromic region of bezel cover covering display screen housed within outer enclosure of conferencing device located within workspace. Method may furthermore include transmitting instructions to energize electrochromic region when authentication is successful. Other embodiments of this aspect include corresponding computer systems, apparatus, and computer programs recorded on one or more computer storage devices, each configured to perform the actions of the methods.

Implementations may include one or more of the following features. Method where said three-dimensional object further may include additional security token embedded therein. Method where upon receipt of security token from mobile user device remote cloud server commences additional sequence of authentication workflow steps prior to transmission instruction for energizing electrochromic region. Method where said workspace management system further may include a remote cloud server having network interface communicatively coupled thereto, the remote cloud server including CPU and nonvolatile storage tangibly embodying instructions executable by said central processing unit for generating authentication token to be shown on display screen portion of conferencing device, encoding authentication token in QR-Code for display on said display screen, transmitting authentication token to conferencing device. Implementations of the described techniques may include hardware, a method or process, or a computer tangible medium.

In one general aspect, computer readable medium storing instructions may include receiving data containing information captured by an optical imaging camera and first LIDAR camera disposed on same side of mobile user device. Computer readable medium storing instructions may also include authenticating using at least one three-dimensional object encoded with symbology for representing data in x, y, z directions that is disposed behind electrochromic region of bezel cover covering display screen housed within outer enclosure of conferencing device located within workspace. Instructions may furthermore include transmitting instruction energize electrochromic region when successful authentication occurs. Other embodiments of this aspect include corresponding computer systems, apparatus, and computer programs recorded on one or more computer storage devices, each configured to perform the actions of the methods.

Implementations may include one or more of the following features. Computer readable medium where said three-dimensional object further may include additional security token embedded therein. Computer readable medium where upon receipt of security token from mobile user device remote cloud server commences additional sequence of authentication workflow steps prior to transmission instruction for energizing electrochromic region. Computer readable medium where said processor configured with memory resources further may include remote cloud server having network interface communicatively coupled thereto, the remote cloud server including CPU and nonvolatile storage tangibly embodying instructions executable by said central processing unit for generating authentication token to be shown on display screen portion of conferencing device, encoding authentication token in QR-Code for display on said display screen, transmitting authentication token to conferencing device. Implementations of the described techniques may include hardware, a method or process, or a computer tangible medium.

In one general aspect, method may include receiving, by a workspace management system from a mobile user device having an optical imaging camera and first LIDAR camera disposed on the same side of said mobile user device, data containing information captured by said optical imaging camera and said first LIDAR camera. Method may also include authenticating, by the workspace management system using at least one three-dimensional object encoded with symbology for representing data in x, y, and z directions that is disposed behind an electrochromic region of bezel cover covering display screen housed within outer enclosure of conferencing device located within workspace. Method may furthermore include transmitting instructions to energize electrochromic region when authentication is successful. Other embodiments of this aspect include corresponding computer systems, apparatus, and computer programs recorded on one or more computer storage devices, each configured to perform the actions of the methods.

Implementations may include one or more of the following features. Method where said three-dimensional object further may include additional security token embedded therein. Method where upon receipt of security token from mobile user device remote cloud server commences additional sequence of authentication workflow steps prior to transmission instruction for energizing electrochromic region. Method where said workspace management system further may include a remote cloud server having network interface communicatively coupled thereto, the remote cloud server including CPU and nonvolatile storage tangibly embodying instructions executable by said central processing unit for generating authentication token to be shown on display screen portion of conferencing device, encoding authentication token in QR-Code for display on said display screen, transmitting authentication token to conferencing device. Implementations of the described techniques may include hardware, a method or process, or a computer tangible medium.

In one general aspect, computer readable medium storing instructions may include receiving data containing information captured by an optical imaging camera and first LIDAR camera disposed on same side of mobile user device. Computer readable medium storing instructions may also include authenticating using at least one three-dimensional object encoded with symbology for representing data in x, y, z directions that is disposed behind electrochromic region of bezel cover covering display screen housed within outer enclosure of conferencing device located within workspace. Instructions may furthermore include transmitting instruction energize electrochromic region when successful authentication occurs. Other embodiments of this aspect include corresponding computer systems, apparatus, and computer programs recorded on one or more computer storage devices, each configured to perform the actions of the methods.

Implementations may include one or more of the following features. Computer readable medium where said three-dimensional object further may include additional security token embedded therein. Computer readable medium where upon receipt of security token from mobile user device remote cloud server commences additional sequence of authentication workflow steps prior to transmission instruction for energizing electrochromic region. Computer readable medium where said processor configured with memory resources further may include remote cloud server having network interface communicatively coupled thereto, the remote cloud server including CPU and nonvolatile storage tangibly embodying instructions executable by said central processing unit for generating authentication token to be shown on display screen portion of conferencing device, encoding authentication token in QR-Code for display on said display screen, transmitting authentication token to conferencing device. Implementations of the described techniques may include hardware, a method or process, or a computer tangible medium.

In one general aspect, workspace management system may include a mobile user device having first side and second side, the mobile user device including an optical imaging camera positioned on said first side of said mobile user device, a first LIDAR camera disposed on said first side. Workspace management system may also include conferencing device located within workspace, the conferencing device configured with outer enclosure that includes display screen housed therein and bezel cover covering over at least portion of the perimeter edges thereof where same bezel cover is transparent to frequency used by said LIDAR camera such that three-dimensional object encoded with symbology for representing data in x, y z, directions does not interfere or obstruct light beam projected from said lidar camera when electro chromatic region has been energized. System may furthermore include remote cloud server having network interface communicatively coupled thereto where nonvolatile storage tangibly embodies instructions executable by central processing unit for generating authentication token to be shown on display screen portion of conferencing device and encoding authentication token in QR-Code for display on said display screen transmitting authentication token to conferencing system, where said remote cloud server further includes workspace automation application having event scheduling engine adapted to allow an user to preprogram user profiles, presents, scenes, building rules and schedule of events of electronic devices the workspace. System may in addition include a network switch communicatively connected to cloud network and local area; where said remote cloud server further includes control engine adapted to send at least one command for controlling electronic devices located within workspace where command is one of commanding power on/off or dimming lighting device or adjusting temperature setpoint of HVAC system. System may moreover include where said processor configured with memory resources further may include remote cloud server having network interface communicatively coupled thereto, the remote cloud server including CPU and nonvolatile storage tangibly embodying instructions executable by said central processing unit for generating authentication token to be shown on display screen portion of conferencing device, encoding authentication token in QR-Code for display on said display screen, transmitting authentication token to conferencing device. Other embodiments of this aspect include corresponding computer systems, apparatus, and computer programs recorded on one or more computer storage devices, each configured to perform the actions of the methods.

Implementations may include one or more of the following features. Workspace management system where said three-dimensional object further may include additional security token embedded therein. Workspace management system where upon receipt of security token from mobile user device remote cloud server commences additional sequence of authentication workflow steps prior to transmission instruction for energizing electrochromic region. Workspace management system where said bezel cover is transparent to the frequency of the light used by said first LIDAR camera. Workspace management system where said QR-Code is encoded with a tokenized URL that points to a link for downloading an application on to said mobile user device. Workspace management system where said remote cloud server further includes an authentication engine adapted to authenticate said mobile user device using said three-dimensional object encoded with symbology for representing data in x, y, and z directions. Workspace management system where said authentication engine is further adapted to authenticate user using biometric data associated with said mobile user device. Workspace management system where said biometric data is selected from the group having of: fingerprint, voice recognition, facial recognition, and iris scan. Workspace management system where said remote cloud server further includes an user interface adapted to receive user input and display information related to the operation of said workspace management system. Workspace management system where said remote cloud server further includes a data storage component adapted to store user profiles, presents, scenes, building rules and schedule of events of said electronic devices the workspace. Workspace management system where said remote cloud server further includes a control engine adapted to send at least one command for controlling electronic devices located within workspace where command is one of commanding power on/off or dimming lighting device or adjusting temperature setpoint of HVAC system etc. Workspace management system where said remote cloud server further includes a network switch communicatively connected to cloud network and local area. Workspace management system where said remote cloud server further includes a communication module adapted to communicate with external systems such as security, energy monitoring and other building automation systems. Workspace management system where said remote cloud server further includes a data analytics module adapted to analyze usage patterns of electronic devices within the workspace and generate reports for users. Workspace management system where said remote cloud server further includes a reporting module adapted to generate reports related to usage of electronic devices within the workspace. Workspace management system where said remote cloud server further includes an event scheduling engine adapted to schedule events for controlling electronic devices located within the workspace. Workspace management system where said remote cloud server further includes a notification engine adapted to send notifications related to the operation of electronic devices within the workspace. Workspace management system where said remote cloud server further includes a rules engine adapted to generate rules for controlling electronic devices located within the workspace. Workspace management system where said remote cloud server further includes a data mining module adapted to analyze usage patterns of electronic devices within the workspace and generate reports for users. Workspace management system where said remote cloud server further includes a billing engine adapted to generate bills related to usage of electronic devices within the workspace. Workspace management system where said remote cloud server further includes a security module adapted to secure communication between the remote cloud server and electronic devices located within the workspace. Workspace management system where said remote cloud server further includes a data encryption module adapted to encrypt communication between the remote cloud server and electronic devices located within the workspace. Workspace management system where said remote cloud server further includes a device monitoring module adapted to monitor status of electronic devices located within the workspace. Workspace management system where said remote cloud server further includes a data logging module adapted to log usage of electronic devices within the workspace. Workspace management system where said remote cloud server further includes an artificial intelligence module adapted to learn usage patterns of electronic devices within the workspace and suggest recommendations for controlling them. Workspace management system where said artificial intelligence module is adapted to predict user needs based on learned usage patterns. Workspace management system where said remote cloud server further includes a machine learning module adapted to learn usage patterns of electronic devices within the workspace and suggest recommendations for controlling them. Workspace management system where said remote cloud server further includes an optimization module adapted to optimize usage of electronic devices within the workspace by controlling them based on user preferences and energy efficiency requirements. Workspace management system where said remote cloud server further includes a machine vision module adapted to detect and recognize objects within the workspace using image processing techniques. Implementations of the described techniques may include hardware, a method or process, or a computer tangible medium.

In one general aspect, method may include providing access control information associated with each user. Method may also include receiving authentication request from mobile user device of respective users via network. Method may furthermore include authenticating requested users by comparing received authentication request against stored access control information related to respective users. Method may in addition include establishing secure communication channel between remote cloud server and requesting mobile user device based on authenticated identity of requesting user. Method may moreover include receiving input command relating operation of at least one electronic device located within the workplace from remotely connected mobiles use devices over established secure communication channels. Method may also include executing commands sent by securely connected clients resulting into desired state change in controlled electronic devices or retrieval of data therefrom. Other embodiments of this aspect include corresponding computer systems, apparatus, and computer programs recorded on one or more computer storage devices, each configured to perform the actions of the methods.

Implementations may include one or more of the following features. Method may include authenticating user using biometric data associated with said mobile user device, where said biometric data is selected from the group having of: fingerprint, voice recognition, facial recognition and iris scan. Method may include receiving input command relating operation of at least one electronic device located within the workplace via a graphical user interface provided on remotely connected mobiles use devices over established secure communication channels. Implementations of the described techniques may include hardware, a method or process, or a computer tangible medium.

### BRIEF DESCRIPTION OF THE SEVERAL VIEWS OF THE DRAWINGS

The drawing figures depict one or more implementations in accord with the present teachings, by way of example only, not by way of limitation. In the figures, like reference numerals refer to the same or similar elements. Furthermore, the drawings are not necessarily to scale.

FIG. 1 depicts examples of a one-dimensional and a two-dimensional barcode.

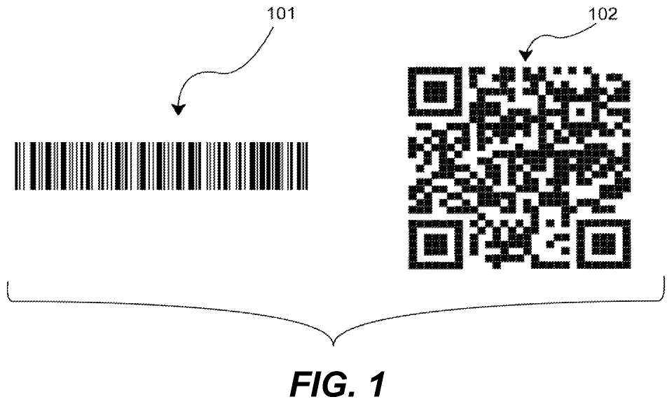

FIG. 2 illustrates a three-dimensional object encoded with a symbology for representing data, according to an embodiment.

FIG. 3 illustrates a three-dimensional object encoded with four distinct symbols representing values one to four, according to an embodiment.

FIG. 4 illustrates a conferencing device, according to an embodiment.

FIG. 5 illustrates a conferencing device with a portion of its bezel cover cutaway to reveal a three-dimensional object used for authentication, according to an embodiment.

FIG. 6 illustrates a illustrates a conferencing device having a LIDAR readable three-dimensional object selectively concealed by an electrochromic bezel configured to varying its opacity, according to an embodiment.

FIG. 7 illustrates a conferencing device having a LIDAR readable three-dimensional object selectively concealed by a electrochromic bezel configured to varying its opacity, according to another embodiment of the present disclosure.

FIG. 8 illustrates a block diagram depicting a workspace management system, according to an embodiment.

FIG. 9 is a flowchart of an example process 900.

FIG. 10 is a flowchart of an example process 1000.

FIG. 11 is a flowchart of an example process 1100.

FIG. 12 is a flowchart of an example process 1200

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different elements may be described or claimed as “configured” to perform one or more tasks or operations. This formulation is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “secure circuit configured to perform an authentication” is intended to cover, for example, an integrated circuit that has circuitry that performs this function during operation, even if the integrated circuit in question is not currently being used (e.g., a power supply is not connected to it). Thus, an entity described or recited as “configured to” perform some tasks refers to something physical, such as a device, circuit, memory storing program instructions executable to implement the task, etc. This phrase is not used herein to refer to something intangible. Thus, the “configured to” construct is not used herein to refer to a software entity such as an application programming interface (API). The term “configured to” is not intended to mean “configurable to.” An unprogrammed FPGA, for example, would not be considered to be “configured to” perform some specific function, although it may be “configurable to” perform that function and may be “configured to” perform the function after programming.

As used herein, the terms “first,” “second,” etc. Are used as labels for nouns that they precede, and do not imply any type of ordering (e.g., spatial, temporal, logical, etc.) unless specifically stated. For example, a mobile user device may have a first user and a second user. The term “first” is not limited to the initial user of the device. The term “first” may also be used when only one user of the mobile user device exists.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION OF THE INVENTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The terms “LIDAR camera,” “3D scanner,” and “3D camera” refer to a device or system that is capable of performing scanning data that is encoded in a 3D object (e.g. 3D QR Code). A 3D camera will include a processor and one or more sensors that can sense and range-find the physical attributes of the objects. Several technologies including structured light, light detection and ranging (LIDAR), optical time-of-flight, ultrasonic ranging, stereoscopic imaging, radar, and so forth either alone or in combination with one another. For convenience, and not by way of limitation, some of the examples in this disclosure refer to LIDAR and determining ranges (variable distance) by targeting an object or a surface with a laser and measuring the time for the reflected light to return to the receiver, however, other techniques may be used. For example, an image sensor (camera), sonic sensor (e.g., sonar), a magnetic sensor, an x-ray device, a combination of an infrared camera with an infrared light source, an air-knife type of reader, or other sensors. The processor will implement programming instructions, typically using parameters from a data file that cause the sensor to collect data that is embedded in a 3D barcode. As used throughout this disclosure, the terms “three-dimensional scanner,” “3D scanning device,” “3D scanning system,” and “3D scanner” refer to any now or hereafter known 3D scanning camera.

Embodiments of the workspace management system can be used in small, mid, or large scale residential or commercial installations. While the embodiments are described herein as being implemented for in use with buildings having one or more shared workspaces, they are not limited to such an implementation. The present embodiments may be employed in other type of venues or facilities, including in residential, retail, or non-profit structures or venues. Additionally, while the workspace management system described herein as managing and controlling an entire building, it may be scaled up to manage a collection of buildings or scaled down to manage a single workspace within a building. Workspace systems can be implemented as one or more dedicated servers which provide convenient control and monitoring of various mechanical and electrical equipment within a building. Workspace systems can utilize a network of sensors and associated controllers located throughout a building to monitor and control the mechanical and electrical equipment in the building. Examples include heating, ventilation, and air conditioning, lighting, shading, security, appliances, door locks, and audiovisual (AV) equipment in each workspace.

The following are definitions of exemplary terms used throughout the disclosure. Both singular and plural forms of all terms fall within each meaning:

“Mobile Application” or “Mobile App” or “App” as used herein, includes, but is not limited to, applications that run on smart phones, tablet computers, and other mobile user devices. The terms “Mobile Application” or “Mobile App” or “App” can be used synonymously with “software”. Mobile applications allow users to connect to services, access the internet, intranet, cellular, or wireless fidelity (Wi-Fi) networks, to access, retrieve, transmit and share data.

“Computer” or “processing unit” as used herein includes, but is not limited to, any programmed or programmable electronic device, microprocessor, logic circuit, that can store, retrieve, and process data.

The term “Network” as used herein refers to a collection of hardware components and computers or machines interconnected by one or more communication channels that allow sharing of resources, data, and information, including without limitation, the worldwide web or internet. A network can be “wireless” or wired or a combination of a wireless and/or wired communication.

A “Web browser” as used herein, includes, but is not limited to, a software for retrieving and presenting information resources on the World Wide Web. An information resource may be a web page, an image, a video, or any other type of electronic content.

A “Server” as used herein, includes, but is not limited to, a computer or a machine or a device on a network that manages network resources. A “server” may refer one or more server computers configured to provide certain server functionalities, such as database management and search engines. A server may also include one or more processors to execute computer programs in parallel. The general term “Server” may include specific types of servers, such as a File Server (a computer and storage device dedicated to storing files), Print Server (a computer that manages one or more printers), a Network Server (a computer that manages network traffic), and a Database Server (a computer system that processes database queries). Although servers are frequently dedicated to performing only server tasks, certain multiprocessing operating systems allow a server to manage other non-server related resources.

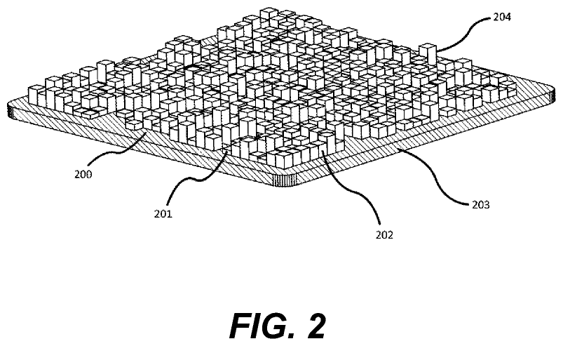

Referring to FIG. 2, a three-dimensional object encoded with a symbology for representing data has base 203 having a plurality of cuboids of varying heights 201, 202, and 204 disposed thereon. The cuboids are arranged to cover each black square of a 2D QR-Code, however as described below, additional symbology is encoded in the height of each cuboid.

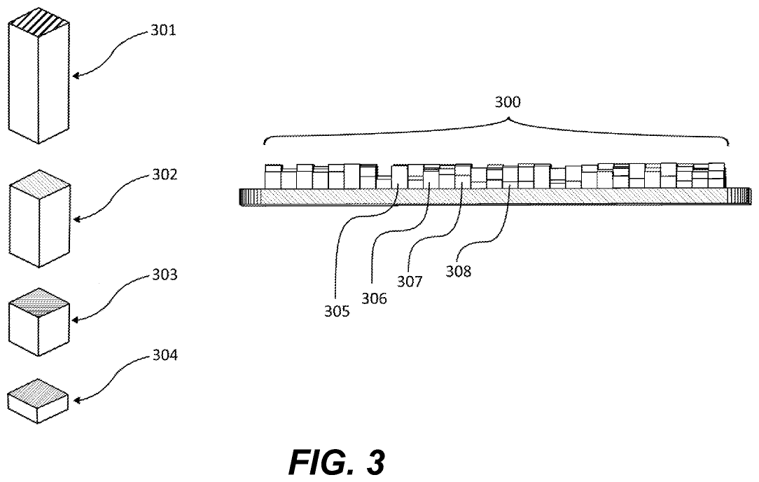

FIG. 3 illustrates a three-dimensional object encoded with four distinct symbols. By varying a cubiod's height additional information can be encoded in to the object when captured, for example, using a 3D LIDAR camera. In one embodiment, Cuboid 304 height represents a value of one, cuboid 303 height represents a value of two, cuboid 302 height represents a value of three, and cuboid 304 height represents a value of four. Cuboids 305-308 illustrate cuboids 301-304, respectively, when used together in collection 300.

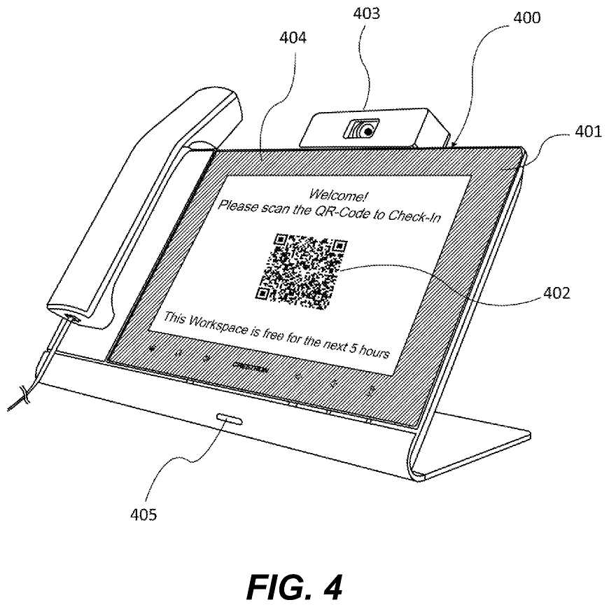

FIG. 4 illustrates an example of conferencing device 400. In this embodiment the conferencing device 400 is a Crestron Flex Phone available from Crestron Electronics, Inc. Of Rockleigh, N.J. In this embodiment, conferencing device 400 has video camera 403, available from Crestron Electronics, Inc. Of Rockleigh, N.J. Microphone 405 may be an Integrated high-fidelity array microphone or a Omnidirectional microphone array with 360-degree audio pickup, display screen 404 that may be a 10″ high resolution touch screen, and bezel 404. In an embodiment, Conferencing device 400 may include an embedded occupancy for capturing meeting-space data and usage analytic, be powered over ethernet as an IEEE 802.3af Class 3 and 802.3at Class 4 PoE powered device, include a USB-C for an audio headset, and include a 1000Base-T Ethernet port & PoE PD port for connection to a LAN with PoE PSE. Display screen 404 may present QR-Code 402.

In the embodiments described below, a QR-Code 402 may be used to encode location information, for example, workspace location, while in other embodiments, QR-Code 402 may encode information other than location information. For example, the QR-code may encode a URL or IP address that is associated with a remote cloud server. In other embodiments, the QR-code may encode a binary string that is associated with an authentication token for the conferencing device. In the instance where the QR-code encoding further comprises a security token and that token is sent by a mobile user device by the remote cloud server, additional authentication steps my commence. That is, upon remote cloud server receiving the token from a mobile user device, the remote cloud server can proceed with an additional sequence of authentication workflow.

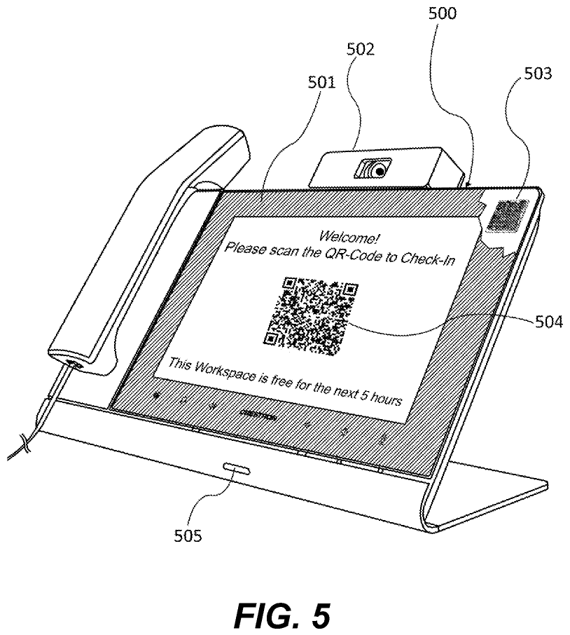

FIG. 5 illustrates a modified conferencing device shown in FIG. 4 however, a portion of its bezel cover is cutaway to reveal a three-dimensional authentication object 503 that is encoded with additional information that can be used for an additional authentication workflow, according to an embodiment. Three-dimensional authentication object 503 is a LIDAR readable object disposed behind the bezel cover 501. In some implementations of the invention, bezel cover 501 may include various types of transparent glass, plastic, or similar transparent or semi-transparent materials that are transparent to frequencies associated with LIDAR, as disclosed in U.S. Pat. No. 9,829,578 B2 to Chaudhry, which incorporated herein by reference in its respective entirety.

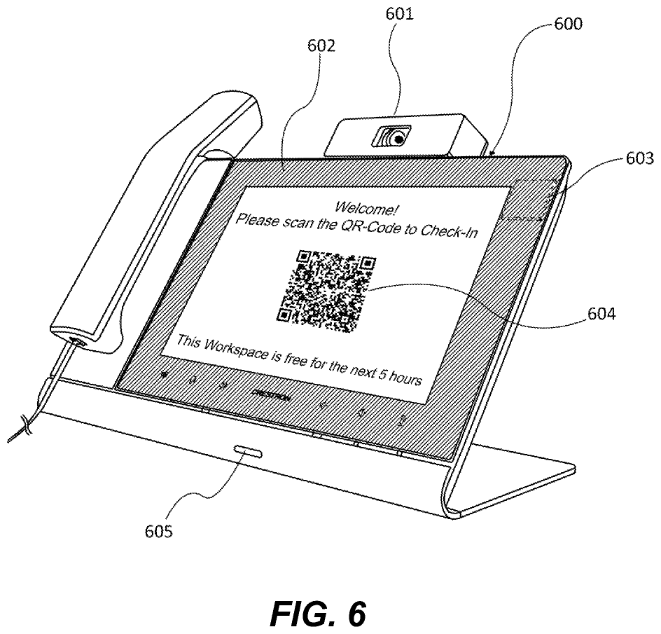

FIG. 6 illustrates a illustrates a conferencing device having a LIDAR readable three-dimensional object 603 selectively concealed by bezel cover 602 configured to be electrochromic and vary its opacity. In one embodiment, all, or a portion of conference device 600 bezel cover 602 is designed to selectively conceal the LIDAR readable three-dimensional object 603 by varying its opacity using electrochromic, photochromic, thermochromic, suspended particle, micro-blind and/or a liquid crystal device. In these embodiments, the bezel cover has at least two modes. In the first mode (“visible mode”) the bezel cover is substantially transparent and allows the frequencies used by the LIDAR camera's optical beam to therethrough. In the second mode (or “concealed mode”) the bezel cover 602 is substantially opaque or substantially interferes with the ability of the LIDAR camera's optical beam to pass through. In an embodiment, the properties of electrochromatic or TN film used results in the bezel cover becoming opaque or dark when de-energized and transparent when energized. Similar suitable materials have been used as a window treatment for homes and commercial building for the control of sunlight and radiant energy.

An embodiment of the foregoing implementation, extends the bezel cover 602 configuration to include modes which concurrently affect the transmission and concealment of visible light (e.g., wavelengths in the range of 400-700 nanometers), thereby allowing the user interacting with the conferencing device 600 to see when they have been granted authorization to scan the hidden LIDAR readable three-dimensional object 603 disposed behind the bezel cover 602, because the inclusion of visible light allows the user to visually detect whether a transparent portion of bezel cover 602 is revealing a LIDAR readable three-dimensional object 603 or if, for example, the bezel cover 602 continues to remain opaque or dark.

In another embodiment, more than one uniquely encoded LIDAR readable three-dimensional object 603 disposed in different areas behind the bezel cover 602 and conferencing device 600 bezel cover 602 is configured to reveal only one of the LIDAR readable three-dimensional objects 603 according to a programed sequence for any authentication logic. In this way, different areas of the bezel cover 602 can be configured to act as independently-operable electrochromic shutters (arranged over several LIDAR readable three-dimensional objects 603) that selectively open and close at the appropriate time for any authentication process desired. The conferencing device 600 can alternatively include MEMS mechanical shutters or any other suitable type of shutter interposed between one or more LIDAR readable three-dimensional objects 603 and bezel cover 602.

In one embodiment, the conferencing device 600 selectively controls the bezel cover's opacity in order prevent the scanning of an adjacent LIDAR readable three-dimensional object (by blocking a LIDAR camera's ability to project a light beam on to its surface) until a user has completed a specific preliminary user check-in, or a basic authentication challenge. In some embodiments, a specific preliminary user check-in comprises having a user point their user communication device camera at a QR-Code 604 currently displayed on the display screen of the conferencing device. The QR-Code 604 is encoded with a tokenized URL that points to a link for downloading an application from the mobile user device's authorized App store. The tokenized URL downloads and installs the new application, uses the login credentials from the encoded information in order to complete a preliminary user check-in. A networked workspace scheduling server can generate, manage, store, and transmit tokenized URLs over a network to the conferencing device 600.

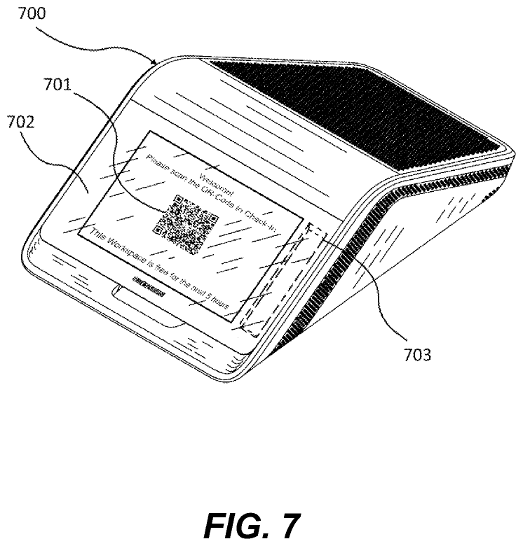

FIG. 7 illustrates a conferencing device 700, and in this embodiment, the conferencing device 700 is a Crestron Mercury®, available from Crestron Electronics, Inc. Of Rockleigh, N.J. Conferencing device 700 is shown displaying QR-Code 701, and comprises a LIDAR readable three-dimensional object region 703 disposed behind bezel cover 702. Conferencing device 700 may include a 7″ (178 mm) HD color touch screen, Active Directory® authentication, Room scheduling integration with Microsoft® Exchange or Crestron Fusion®, Built-in PinPoint™ beacon for use with the Crestron PinPoint App, a Built-in PIR occupancy detector for persistent occupancy awareness combining motion and voice detection, be configurable using a web browser, include Dual LAN ports, be powered via PoE+ or AC line powered, and include CEC, IP, IR, or RS-232 display control.

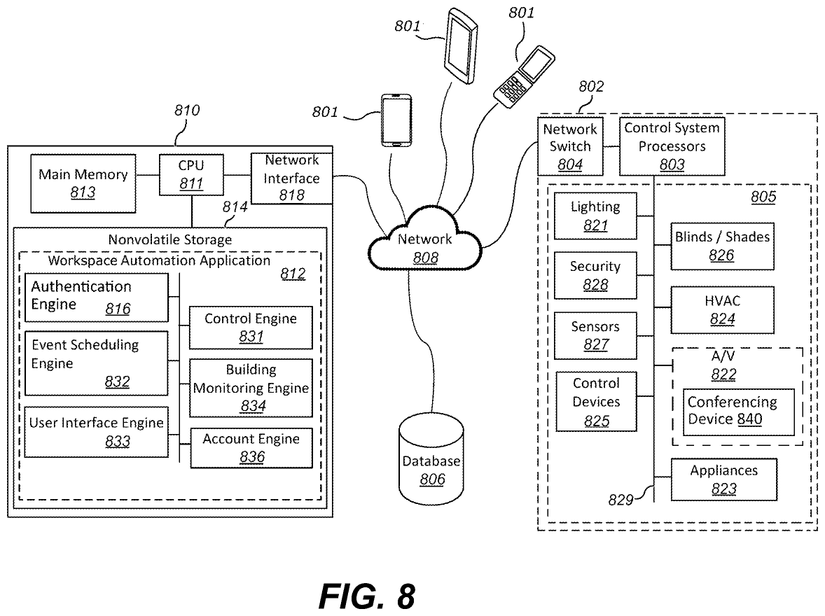

FIG. 8 illustrates a block diagram depicting a workspace management system for controlling and managing one or more workspaces, such as workspace 802, according to an embodiment. It should be noted that the exemplary embodiment of workspace management system illustrated in FIG. 8 may be varied in one or more aspects without departing from the spirit and scope of the teachings disclosed herein. Workspace management system may comprise one or more mobile user device 801, remote cloud server 810, a database 806, a cloud network 808, and various devices installed in the workspace 802 such as Control System Processor 803 and electronic devices 805.

According to an embodiment, the present embodiments deliver workspace management via cloud computing on remote cloud server 810. The remote cloud server 810 may comprise or be associated with a workspace automation application 812 configured for providing a user interface on the mobile user device 801 with which the user can interact with the workspace management system. By leveraging remote access to the Control System Processor 803 and/or the controllable electronic devices 805 via remote cloud server 810, a user may monitor and control the devices 805 and/or environment settings in a workspace 802 using any mobile user device 801. The workspace automation application 812 provides a user interface on the mobile user device 801 in communication with the remote cloud server 810 allowing a user to setup scheduled events to control electronic devices 805 within the workspace 802. However, according to another embodiment, the workspace automation application 812 may alternatively reside on a control system processor 803.

Mobile user device 801 may access the services provided by the remote cloud server 810 using a web-browser such as Internet Explorer, Microsoft Edge, Firefox, Google Chrome, Opera, Safari, or the like. While the embodiments are described herein as accessing remote cloud server 810 via a web-browser, the present embodiments are not limited to such an implementation. According to other embodiments, the mobile user device 801 may comprise a proprietary native mobile app, or other similar software application, configured for accessing remote cloud server 810 via the cloud network 808. Mobile user device 801 may be any mobile user devices known in the art, including, but not limited to a laptop, a portable electronic device, a mobile computer, a smartphone, a tablet, a personal digital assistant, or any other computer configured for communicating with a remove server, such as remote cloud server 810, via a cloud network through a web-browser or other similar application. Each mobile user device 801 may comprise a central processing unit (CPU), a user interface, one of numerous forms of storage (e.g., solid-state memory (RAM, ROM, and the like), and a wireless network interface such as an interface to a wireless LAN, Wi-Fi, 802.11x wireless network, cellular data network (such as the EDGE, LTE, 3G, 4G, or 5G network.) Using its wireless network interface, each mobile user device 801 can communicate with remote cloud server 810 via the cloud network 808.

Cloud network 808 can incorporate one or more of the Internet, a wide area network (WAN), a local area network (LAN), a personal area network (PAN), a wireless network, a campus area network (CAN), a metropolitan area network (MAN), or the like. Cloud network 808 may include a public switched telephone network (PSTN), a cable telephony network, an Internet Protocol (IP) telephony network, a wireless network, a hybrid Cable/PSTN network, a hybrid IP/PSTN network, a hybrid wireless/PSTN network or any other suitable cloud network or combination of cloud networks. In addition, other network embodiments can be deployed with many variations in the number and type of devices, cloud networks, communication protocols, system topologies, and a myriad of other details without departing from the spirit and scope of the present embodiments. Cloud network 808 may include one or more gateway devices to provide with an entrance to cloud network 808, which may include software and/or hardware components to manage traffic entering and exiting cloud network 808 and conversion between the communication protocols used by various communication devices.

The workspace management system may further comprise one or more Control System Processor 803 or gateways in communication with the remote cloud server 810 via Network Switch 804 to cloud network 808. Control System Processor 803 may be connected to various electronic devices 805 throughout workspace 802 using local area network 829 via wireline or wirelessly. The Control System Processor 803 may provide a web interface for remote cloud server 810 to be displayed on a conferencing device 840 located within the workspace 802. The control system processor 803 is used for, among other things, controlling and monitoring various devices and environmental conditions throughout a structure. The control system processor 803 may, for example, be any Control System available from Crestron Electronics, Inc. Of Rockleigh, N.J. The Control System Processor 803 may comprise similar components as remote cloud server 810 as further described below. The Control System Processor 803 may further provide a time-clock function to event scheduling engine 832.

The Control System Processor 803 may control one or more of the following electronic devices: lighting devices 821, including but not limited to lamps, ballasts, light emitting diode (LED) drivers; HVAC devices 824 including but not limited to thermostats, air conditioning units, heating units, filtration systems, fans, humidifiers; shading devices 826 including but not limited to motorized window treatments, dimmable windows; sensors 827, including but not limited to occupancy sensors, proximity sensors, sound sensors, microphones, temperature sensors. AV devices 822 include, but not limited to, telephones, video phones, video touch panels, and a conferencing device 840. Examples of conferencing device 840 may include, Crestron Mercury® Tabletop UC Audio Conference Console and Crestron Flex® Phones available from Crestron Electronics, Inc. Of Rockleigh, N.J.

Security devices 828 may include, but are not limited to, security cameras, monitors, electronic safes, and door locks. Appliances 823 may include, but are not limited to, refrigerators, ovens, blenders, microwaves. Control devices 825 include, but are not limited to, switches, relays, and current limiting devices. Other types of electronic devices 805 are contemplated depending on the implementation of the workspace 802. As indicated above, according to an embodiment, one of the Control System Processor 803 may instead comprise the workspace automation application 812.

One or more network interfaces may provide connectivity between the Control System Processor 803 and electronic devices 805, and among the electronic devices 805 via the local area network 829. The network interface may represent, for example, one or more network interface cards (NIC) or a network controller. In certain embodiments, the network interface may include a PAN interface. The PAN interface may provide capabilities to network with, for example, a Bluetooth® network, an IEEE 802.15.4 (e.g. Zigbee network), or an ultra-wideband network. As should be appreciated, the networks accessed by the PAN interface may, but do not necessarily, represent low power, low bandwidth, or close-range wireless connections. The PAN interface may permit one electronic device 805 to connect to another local electronic device 805 via an ad-hoc or peer-to-peer connection. The Control System Processor 803 may directly communicate to the electronic devices 805 via the local area network 829 or may communicate using the ad-hoc or peer-to-peer communication capability of electronic device 805 to communicate with another device.

The network switch may also include a LAN interface. The LAN interface may represent an interface to a wired Ethernet-based network but may also represent an interface to a wireless LAN, such as an 802.11x wireless network. Additionally, in many cases, a connection between two electronic devices 805 via the LAN interface may involve communication through a network router or other intermediary device. Ethernet connectivity enables integration with IP-controllable devices and allows the Control System Processor 803 to be part of a larger managed network. Whether residing on a sensitive corporate LAN, a home network, or accessing the Internet through a cable modem, control system processor 803 may provide secure, reliable interconnectivity with IP-enabled devices, such as touch screens, computers, mobile user devices, video displays, Blu-ray Disc® players, media servers, security systems, lighting, HVAC, and other equipment-both locally and globally. For some embodiments, the network interfaces may include the capability to connect directly to a WAN via a WAN interface. The WAN interface may permit connection to a cellular data network, such as the EDGE, LTE, 3G, 4G, or 5G network.

The Control System Processor 803 and electronic devices 805 may also include one or more wired input/output (I/O) interface for a wired connection between one electronic device and another electronic device. One or more wired interfaces may represent a serial port, for example a communication (COM) port or a universal serial bus (USB) port. Additionally, the wired I/O interface may represent, for example, a Cresnet® port. Cresnet® connectivity provides a network wiring solution for Crestron keypads, lighting controls, thermostats, and other devices that don't require the higher speeds of Ethernet. The Cresnet® bus offers wiring and configuration, carrying bidirectional communication and 24 VDC power to each device over a simple 4-conductor cable.

One or more infrared (IR) interfaces may enable the Control System Processor 803 and electronic devices 805 to receive and/or transmit signals with infrared light. The IR interface may comply with the Infrared Data Association (IrDA) specification for data transmission. Alternatively, the IR interface may function to receive control signals or to output control signals. The IR interface may provide a direct connection with one or more devices such as a centralized AV sources, video displays, and other devices. One or more programmable relay ports may enable the Control System Processor 803 and/or electronic devices 805, such as control devices 825, to control window shades, projection screens, lifts, power controllers, and other contact-closure actuated equipment. One or more “Versiport” I/O ports may enable the integration of occupancy sensors, power sensors, door switches, or anything device that provides a dry contact closure, low-voltage logic, or 0-10 Volt DC signal.

According to an alternative embodiment, workspace management system may operate without the utilization of Control System Processor 803. Electronic devices 805 dispersed throughout the workspace 802 may operate as a network of devices in communication with the remote cloud server 810 over cloud network 808. According to some aspects of the embodiments, each controllable electronic device 805 may comprise a Power over Ethernet (PoE) interface for receiving electric power as well as for sending and receiving signals over an Internet Protocol (IP) based network.

According to an alternative embodiment, the conferencing device 840 replaces control system processor 803 in workspace 802. In these embodiments, conferencing device 840 is configured to perform the functions of control system processor 803.

Remote cloud server 810 may be used to aggregate multiple Control System Processor 803 into a centralized a workspace management system. The remote cloud server 810 may provide similar functions as the Control System Processor 803 for remote control and also comprise additional services. Remote cloud server 810 may be a dedicated, private server, employing standard security protocols.

In one embodiment, mobile user device 801 can located and communicate with remote cloud server 810 over cloud network 808 using a Uniform Resource Locator (URL) decoded from a QR-Code that mobile user device 801 captures from the display screen of conferencing device 840 using the camera installed in mobile user device 801. In one embodiment, the QR-Code is encoded with a tokenized URL that points to a link for downloading an application from the mobile user device 801 authorized application store (i.e., “App store.”)

Remote cloud server 810 may be incorporated into a standalone server, although in other embodiments, the function of remote cloud server 810 may be distributed across multiple computing systems and architectures. Multiple, redundant servers may be provided for additional backup and security. For example, remote cloud server 810 may include separate web, app, or email servers.

Remote cloud server 810 may comprise one or more network interface 818 to provide connectivity with, among other things, mobile user devices 801, databases 806, Control System Processor 803 and/or electronic devices 805. The network interface 818 may represent, for example, one or more network interface cards (NIC) or a network controller. According to an embodiment, the network interface 818 includes the capability to connect directly to a wide area network (WAN). The network interface 818 may permit a connection to a cellular data network, such as EDGE, LTE, 3G, 4G, or 5G networks.

Remote cloud server 810 may include a CPU 811 configured for providing processing capability to execute an operating system, run various applications, and/or provide processing for one or more of the techniques described herein. For example, the CPU 811 may represent one or more microprocessors, and the microprocessors may be “general purpose” microprocessors, a combination of general and special purpose microprocessors, or application specific integrated circuits (ASICs). Additionally or alternatively, the CPU 811 may include one or more reduced instruction set (RISC) processors, video processors, or related chip sets.

Remote cloud server 810 may further include any one of numerous forms of storage, including main memory 813 and nonvolatile storage 814. Main memory 813 may be communicably coupled to the CPU 811 and may store data and executable code. The main memory 813 may represent volatile memory such as random access memory (RAM), but may also include nonvolatile memory, such as read-only memory (ROM) or Flash memory. In buffering or caching data related to operations of the (Central Processing Unit) CPU 811, the main memory 813 may store data associated with various engines and modules running on the remote cloud server 810. The nonvolatile storage 814 may represent any suitable nonvolatile storage medium, such as a hard disk drive or nonvolatile memory, such as Flash memory. Being well-suited to long-term storage, the nonvolatile storage 814 may store data files such as media (e.g., music and video files), software (e.g., for implementing functions on the remote cloud server 810), and building model data files, among other types of data.

Nonvolatile storage 814 may further include a workspace automation application 812 operable to enable the control and monitoring of electronic devices 805 of the building automation system, as well as perform other operations discussed below. Workspace automation application 812 may comprise a plurality of software engines. Software engines receive, transmit, and process information received from mobile user device 801, database 806, Control System Processor 803, and/or electronic devices 805. Depending upon implementation, various aspects of teachings of the present embodiments may be implemented in a single workspace automation application, a plurality of applications, a single software engine, in a plurality of software engines, in one or more hardwired components or in a combination of hardwired and software systems. In an embodiment, nonvolatile storage 814 comprises authentication engine 816. Authentication engine 816 is operably associated with the main memory 813 and CPU 811. Authentication engine 816 of nonvolatile storage 814 may be leveraged to provide authentication functions for access control for users of mobile user device 801. Authentication engine 816, or portions thereof, may also be utilized to store the data and logic steps needed to carry out authentication of a user using mobile user device 801.

The workspace automation application 812 may be run on the remote cloud server 810 and may comprise a web application-a client-server software application which runs in a web-browser of a client, such as one or more mobile user device 801. In another embodiment, mobile user device 801 comprises a proprietary native mobile app in communication with workspace automation application 812 running on remote cloud server 810. In yet another embodiment, the workspace automation application 812 may be run on one of the Control System Processor 803. The number and types of applications, software engines, and data storage areas may be varied and, as such, the specific arrangement discussed herein is presented primarily for descriptive purposes.

Workspace automation application 812 may comprise an event scheduling engine 832. The event scheduling engine 832 may be configured for allowing a user to preprogram setting user profiles, presents, scenes, building rules, and schedule of event of electronic devices 805 of the workspace automation system, as will be further described below. In other embodiments, control engine 831 is configured for transmitting preprogrammed control commands generated by the event scheduling engine 832.

According to the aspects of the present embodiments, Control System Processor 803 and/or electronic devices 805 communicate with the remote cloud server 810 to receive various control commands. To that end, software engines of remote cloud server 810 may comprise a control engine 831 configured to send at least one command to control the electronic devices 805. Control commands may comprise on-demand commands generated from mobile user device 801. For example, the at least one command may include a command to power on/off or dim a lighting device, control a touch panel, raise/lower the shades, power on/off or adjust the temperature of an HVAC system, enable/disable a security system, power on/off a sensor, power on/off a local computer, or the like. Depending upon implementation, other control commands are contemplated by the present embodiments. In other embodiments, control engine 831 is configured for transmitting preprogrammed control commands generated by the event scheduling engine 832. For example, a scheduled event may generate control commands to turn lights off in the workspace 802 during the end of business hours.

Additionally, Control System Processor 803 may transmit status information of electronic devices 805 of workspace 802. Remote cloud server 810 can comprise a Building monitoring engine 834 configured for monitoring the operation of the workspace 802 and providing this information on a mobile user device 801. Building monitoring engine 834 may be employed to provide real-time or live status information of resources of the building, such as environmental resources and conference room devices. As such, status information may be transmitted to the Building monitoring engine 834 on-demand.

Additionally, status information may be collected and stored on the database 806. The database 806 can be co-located with the remote cloud server 810, or it can be located remotely in among different systems and locations. According to an alternative embodiment, nonvolatile storage 814 further comprises Database 806. Database 806 may include any one of numerous forms of storage devices and storage media, such as solid-state memory, magnetic memory, such as disc drives, and the like, and/or optical memory, such as DVD. Building monitoring engine 834 of remote cloud server 810 may be configured to recall historic status information stored in the database 806.

In addition, nonvolatile storage 814 may comprise an Account engine 836. Remote cloud server 810 may be utilized to provide workspace automation and management services to a plurality of workspaces. In one embodiment, one or more workspaces, such as workspace 802, may be associated with an account. In another embodiment, one or more users may be associated with an account. In yet another embodiment, one or more mobile user device 801 may be associated with an account. Account engine 836 may be configured to create such accounts and correlate data relevant to a particular workspace, such as workspace 802, in these accounts, including system status information of a workspace 802, as well as other data related to workspace 802. Account engine 836 may request a variety of data from a user during a registration process. For example, requests for data may include the workspace location, list of users who are permitted to access the workspace management system of workspace 802, and their names and passwords for registration purposes.

Nonvolatile storage 814 may further comprise authentication engine 816. Authentication engine 816 can verify various types of inputs, including biometrics, information about a 3D objects or scenes, authentication tokens, transactions, and out-of-band authentication requests. In one embodiment, authentication engine 816 can analyze and recognize objects from the 3D data captured by the LIDAR camera of mobile user device 801. In another embodiment, authentication engine 816 can analyze and recognize the topology of a scene at workspace 802. In an embodiment, authentication engine 816 can generate authentication challenges, such as one time PIN codes used for authentication.

In one embodiment, authentication engine 816 can include provisions for generating a token, encoding it into a QR-Code, transmitting it for display on a display screen of conferencing device 840, receiving the decoded token back from mobile user device 801, and after verifying the token selectively controlling the visibility of a three-dimensional authentication object embedded in conferencing device 840. The mobile user device 801 would then be able to scan the three-dimensional authentication object and transmit it to authentication engine 816 for analysis and verification. As describe above, all or a portion of conferencing device 840 device bezel cover is designed to selectively conceal a LIDAR readable three-dimensional object by varying its opacity employing electrochromic, photochromic, thermochromic, suspended particle, micro-blind, liquid crystal device, or the like

In one implementation, authentication engine 816 can ascertain that the authenticated user is given access to all resources the user is approved for. Thus, one function of this process can be linking with account engine 836 to coordinate the username and password credentialing process at conferencing device 840. In one embodiment, this linking can trigger the three-dimensional authentication object authentication workflow described above, in which the user identity is verified and his/her account is accessed.

Account engine 836 may be further configured for providing user authentication to allow access to a particular account and workspace by checking the access of a user by maintaining a database listing access permissions for resources and users as identified by user IDs and passwords, for example.

Nonvolatile storage 81 may also include a user interface engine 833. The user interface engine 833 may be leveraged in association with one or more included software engines and data available in data storage areas to enable visual layout and presentation structure of the building management services provided by remote cloud server 810. User interface engine 833 may be configured to present the visual layout on mobile user device 801.

In one embodiment, the event scheduling engine 832 of the workspace automation application 812 may comprise “Room Categories”, “Room States”, “Day Types”, “Day Patterns”, and “Calendar”. Workspace automation application 812 may be run on the remote cloud server 810 or rendered on mobile user device 801 as a client-server software application.

In another embodiment, the control system processor 803 may comprise similar configuration as remote cloud server 810 and the workspace automation application 812 may be run on a control system processor 803 as an embedded web server which exposes a web interface. The functionality of the workspace automation application 812 may be exposed via a webpage from the device itself. In one embodiment, the users of the system will scan a QR-Code embedded URL and authentication token in order to log into the webpage and thereby be exposed to all functionality allowed by the control system processor 803.

Workspace 802 may comprise many rooms or workspace nodes each identifying a space or a room located within workspace 802. The nodes may be stored on database 806 and accessed by the remote cloud server 810. Although the present description hereafter describes the room nodes as being recalled from database 806 by remote cloud server 810, the present embodiments are not limited thereto. In another embodiment, the room nodes may be stored on a memory of a control system processor 803.

These room nodes may be organized in the memory in a tree topology, with the building as the root, floors as children, and individual spaces as sub-children. Each room node may be associated with one or more electronic devices 805 installed within the workspace 802. This can be accomplished by first performing a discovery process by discovering all the electronic devices 805 connected to the local area network 829 within the workspace 802. The remote cloud server 810 may communicate to the Control System Processor 803 to discover electronic devices 805 connected to the local area network 829. In another embodiment, remote cloud server 810 can communicate directly with electronic devices 805 via cloud network 808 and local area network 829 if, for example, these devices are in direct communication with the remote cloud server 810 without the use of Control System Processor 803. The discovery process may provide a list of electronic devices 805. Each electronic device 805 may be identified by a unique ID, such as the device's serial number, as well as a model number, device name, device type, or the like. Each such electronic device 805 is associated with a room node. For example, all electronic devices 805 located within a conference room may be associated with a conference room node. This association allows for monitoring and controlling the workspace 802 space by space. This association may be stored in database 806.

Using the workspace automation application 812, system user can classify these room nodes of workspace 802 by room type or “Room Categories,” i.e., what the room or space is being used for. This categorization allows all rooms or spaces falling under a specific category to operate in the same way without the need to create separate events for each room. For example, a single scheduling event may be created to turn the lights off in all rooms falling under a “conference room” category at the end of a business day. Room categories may include lobby, hallways, staircases, common areas, conference rooms, private offices, open offices, bathrooms, etc., in workspace 802, or kitchen, living room, bedrooms, bathrooms, etc., in a residential building. The “Room Categories” may comprise default room categories stored in a memory, or can comprise “Room Categories” generated or edited by a user. Room classification by room categories may be changed by the user at any time when the utilization of the space changes.

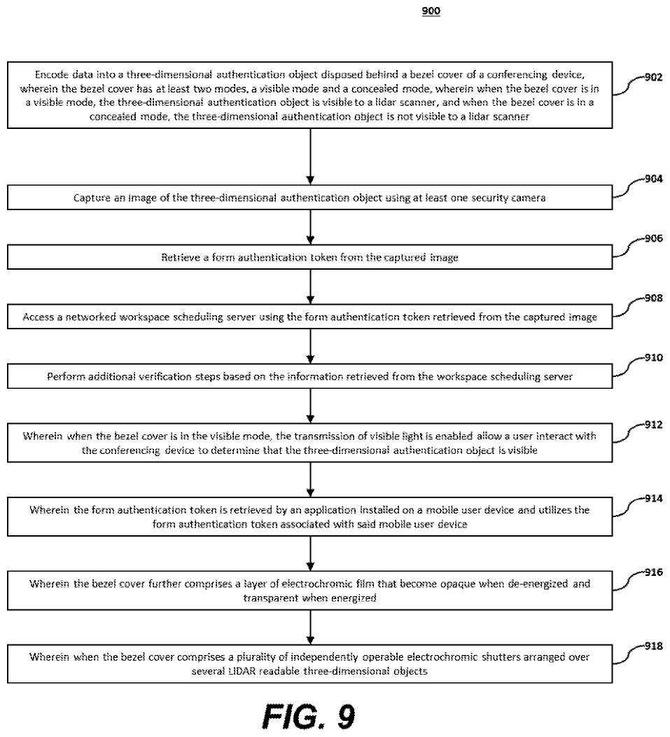

FIG. 9 is a flowchart of an example process 900. In some implementations, one or more process blocks of FIG. 9 may be performed by a device.

As shown in FIG. 9, process 900 may include encoding data into a three-dimensional authentication object disposed behind a bezel cover of a conferencing device, where the bezel cover has at least two modes, a visible mode and a concealed mode, where when the bezel cover is in a visible mode, the three-dimensional authentication object is visible to a lidar scanner, and when the bezel cover is in a concealed mode, the three-dimensional authentication object is not visible to a lidar scanner (block 902). For example, device may encode data into a three-dimensional authentication object disposed behind a bezel cover of a conferencing device, where the bezel cover has at least two modes, a visible mode and a concealed mode, where when the bezel cover is in a visible mode, the three-dimensional authentication object is visible to a lidar scanner, and when the bezel cover is in a concealed mode, the three-dimensional authentication object is not visible to a lidar scanner, as described above. As also shown in FIG. 9, process 900 may include capturing an image of the three-dimensional authentication object using at least one security camera (block 904). For example, device may capture an image of the three-dimensional authentication object using at least one security camera, as described above. As further shown in FIG. 9, process 900 may include retrieving a form authentication token from the captured image (block 906). For example, device may retrieve a form authentication token from the captured image, as described above. As also shown in FIG. 9, process 900 may include accessing a networked workspace scheduling server using the form authentication token retrieved from the captured image (block 908). For example, device may access a networked workspace scheduling server using the form authentication token retrieved from the captured image, as described above. As further shown in FIG. 9, process 900 may include performing additional verification steps based on the information retrieved from the workspace scheduling server (block 910). For example, device may perform additional verification steps based on the information retrieved from the workspace scheduling server, as described above.

Process 900 may include additional implementations, such as any single implementation or any combination of implementations described below and/or in connection with one or more other processes described elsewhere herein. In a first implementation, when the bezel cover is in the visible mode, the transmission of visible light is enabled allow an user interacting with the conferencing device to determine that the three-dimensional authentication object is visible.

In a second implementation, alone or in combination with the first implementation, the form authentication token is retrieved by an application installed on a mobile user device and utilizes the form authentication token associated with said mobile user device.

In a third implementation, alone or in combination with the first and second implementation, the bezel cover further may include a layer of electrochromic film that become opaque when de-energized and transparent when energized.

In a fourth implementation, alone or in combination with one or more of the first through third implementations, when the bezel cover may include a plurality of independently operable electrochromic shutters arranged over several LIDAR readable three-dimensional objects.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

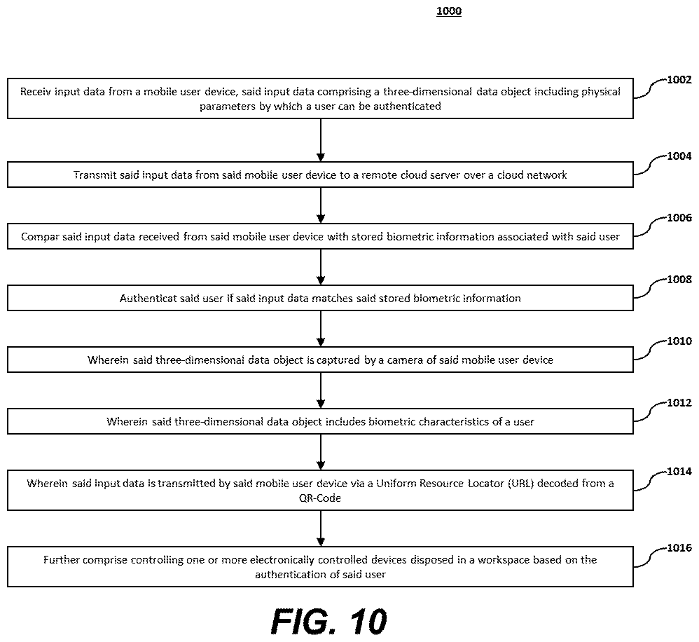

FIG. 10 is a flowchart of an example process 1000. In some implementations, one or more process blocks of FIG. 10 may be performed by a device.

As shown in FIG. 10, process 1000 may include Receiving input data from a mobile user device, said input data having a three-dimensional data object including physical parameters by which an user can be authenticated (block 1002). For example, device may receive input data from a mobile user device, said input data having a three-dimensional data object including physical parameters by which an user can be authenticated, as described above. As also shown in FIG. 10, process 1000 may include Transmitting said input data from said mobile user device to a remote cloud server over a cloud network (block 1004). For example, device may transmit said input data from said mobile user device to a remote cloud server over a cloud network, as described above. As further shown in FIG. 10, process 1000 may include Comparing said input data received from said mobile user device with stored biometric information associated with said user (block 1006). For example, device may compare said input data received from said mobile user device with stored biometric information associated with said user, as described above. As also shown in FIG. 10, process 1000 may include Authenticating said user if said input data matches said stored biometric information (block 1008). For example, device may authenticate said user if said input data matches said stored biometric information, as described above.

Process 1000 may include additional implementations, such as any single implementation or any combination of implementations described below and/or in connection with one or more other processes described elsewhere herein. In a first implementation, said three-dimensional data object is captured by a camera of said mobile user device.

In a second implementation, alone or in combination with the first implementation, said three-dimensional data object includes biometric characteristics of an user.

In a third implementation, alone or in combination with the first and second implementation, said input data is transmitted by said mobile user device via an Uniform Resource Locator (URL) decoded from a QR-Code.

A fourth implementation, alone or in combination with one or more of the first through third implementations, process 1000 may include controlling one or more electronically controlled devices disposed in a workspace based on the authentication of said user.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

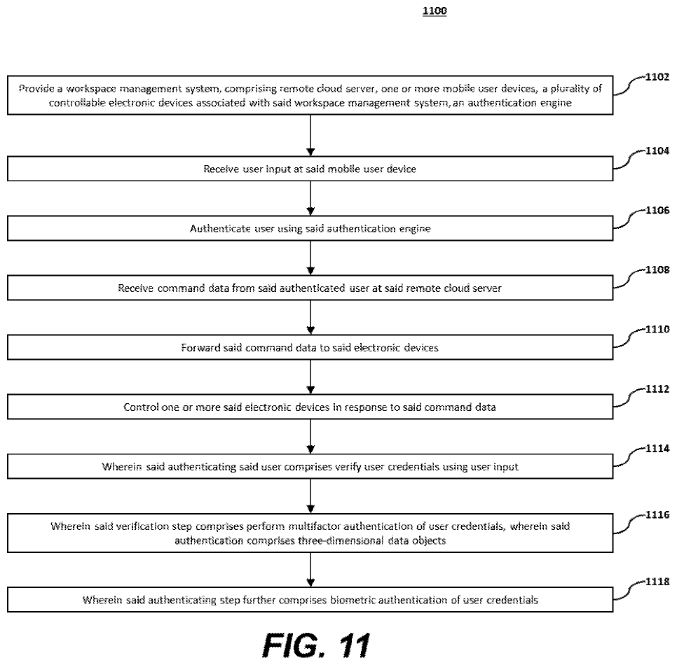

FIG. 11 is a flowchart of an example process 1100. In some implementations, one or more process blocks of FIG. 11 may be performed by a device.

As shown in FIG. 11, process 1100 may include providing a workspace management system, having remote cloud server, one or more mobile user devices, a plurality of controllable electronic devices associated with said workspace management system, an authentication engine (block 1102). For example, device may provide a workspace management system, having remote cloud server, one or more mobile user devices, a plurality of controllable electronic devices associated with said workspace management system, an authentication engine, as described above. As also shown in FIG. 11, process 1100 may include receiving user input at said mobile user device (block 1104). For example, device may receive user input at said mobile user device, as described above. As further shown in FIG. 11, process 1100 may include authenticating user using said authentication engine (block 1106). For example, device may authenticate user using said authentication engine, as described above. As also shown in FIG. 11, process 1100 may include receiving command data from said authenticated user at said remote cloud server (block 1108). For example, device may receive command data from said authenticated user at said remote cloud server, as described above. As further shown in FIG. 11, process 1100 may include forwarding said command data to said electronic devices (block 1110). For example, device may forward said command data to said electronic devices, as described above. As also shown in FIG. 11, process 1100 may include controlling one or more said electronic devices in response to said command data (block 1112). For example, device may control one or more said electronic devices in response to said command data, as described above.

Process 1100 may include additional implementations, such as any single implementation or any combination of implementations described below and/or in connection with one or more other processes described elsewhere herein. In a first implementation, said authenticating said user may include verifying user credentials using user input.

In a second implementation, alone or in combination with the first implementation, said verification step may include performing multifactor authentication of user credentials, where said authentication may include three-dimensional data objects.

In a third implementation, alone or in combination with the first and second implementation, said authenticating step further may include biometric authentication of user credentials.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

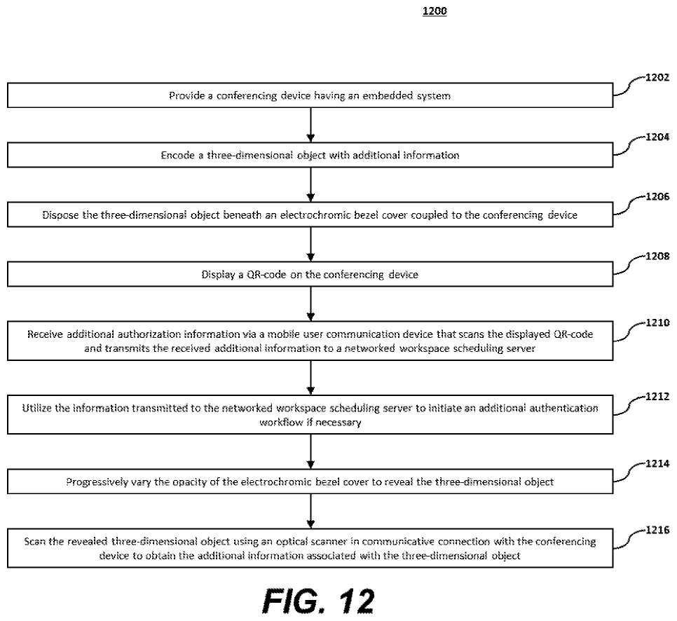

FIG. 12 is a flowchart of an example process 1200. In some implementations, one or more process blocks of FIG. 12 may be performed by a device.

As shown in FIG. 12, process 1200 may include providing a conferencing device having an embedded system (block 1202). For example, device may provide a conferencing device having an embedded system, as described above. As also shown in FIG. 12, process 1200 may include encoding a three-dimensional object with additional information (block 1204). For example, device may encode a three-dimensional object with additional information, as described above. As further shown in FIG. 12, process 1200 may include disposing the three-dimensional object beneath an electrochromic bezel cover coupled to the conferencing device (block 1206). For example, device may dispose the three-dimensional object beneath an electrochromic bezel cover coupled to the conferencing device, as described above. As also shown in FIG. 12, process 1200 may include displaying a QR-code on the conferencing device (block 1208). For example, device may display a qr-code on the conferencing device, as described above. As further shown in FIG. 12, process 1200 may include receiving additional authorization information via a mobile user communication device that scans the displayed QR-code and transmits the received additional information to a networked workspace scheduling server (block 1210). For example, device may receive additional authorization information via a mobile user communication device that scans the displayed qr-code and transmits the received additional information to a networked workspace scheduling server, as described above. As also shown in FIG. 12, process 1200 may include utilizing the information transmitted to the networked workspace scheduling server to initiate an additional authentication workflow if necessary (block 1212). For example, device may utilize the information transmitted to the networked workspace scheduling server to initiate an additional authentication workflow if necessary, as described above. As further shown in FIG. 12, process 1200 may include progressively varying the opacity of the electrochromic bezel cover to reveal the three-dimensional object (block 1214). For example, device may progressively vary the opacity of the electrochromic bezel cover to reveal the three-dimensional object, as described above. As also shown in FIG. 12, process 1200 may include scanning the revealed three-dimensional object using an optical scanner in communicative connection with the conferencing device to obtain the additional information associated with the three-dimensional object (block 1216). For example, device may scan the revealed three-dimensional object using an optical scanner in communicative connection with the conferencing device to obtain the additional information associated with the three-dimensional object, as described above.

Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

In addition, implementations of the present disclosure can make use of any of the features, systems, components, devices, and methods described in

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations, and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a particular processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In implementations in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across a number of machines. Processors or processor-implemented modules may be located in a single geographic location (for example, within a home or office environment, or a server farm), or may be distributed across multiple geographic locations.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims, and their equivalents, in which all terms are meant in their broadest reasonable sense unless otherwise indicated.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, in the case of matching biometric snapshots to the first user identity, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A workspace management system comprising:
a networked workspace scheduling server;
a conferencing device having a three-dimensional authentication object encoded with data that is read using lidar and disposed behind a bezel cover, wherein the bezel cover has at least two modes, a visible mode and a concealed mode, wherein when the bezel cover is in a visible mode, the three-dimensional authentication object is visible to a lidar scanner, and when the bezel cover is in a concealed mode, the three-dimensional authentication object is not visible to a lidar scanner;
a mobile user device having an application installed thereon, wherein the form authentication token associated with the mobile user device and encoded in the three-dimensional authentication object is retrievable by the application; and
at least one security camera for capturing images of the three-dimensional authentication object on the conferencing device.

2. The system of claim 1, wherein when the bezel cover is in the visible mode, the transmission of visible light wavelengths in the range of 400-700 nanometers is enabled allow a user interacting with the conferencing device to determine that the three-dimensional authentication object is visible.

3. The system of claim 1, wherein the bezel cover further comprises a layer of electrochromic film that become opaque when de-energized and transparent when energized.

4. The system of claim 1, wherein when the bezel cover comprises a plurality of independently operable electrochromic shutters arranged over several LIDAR readable three-dimensional objects.

5. The system of claim 1, wherein when the application uses the form authentication token associated with the mobile user device encoded in the three-dimensional authentication object to access the workspace scheduling server.

6. A method of multifactor authentication for configurable workspaces, comprising:
encoding data into a three-dimensional authentication object disposed behind a bezel cover of a conferencing device, wherein the bezel cover has at least two modes, a visible mode and a concealed mode, wherein when the bezel cover is in a visible mode, the three-dimensional authentication object is visible to a lidar scanner, and when the bezel cover is in a concealed mode, the three-dimensional authentication object is not visible to a lidar scanner;
capturing an image of the three-dimensional authentication object using at least one security camera;
retrieving a form authentication token from the captured image;
accessing a networked workspace scheduling server using the form authentication token retrieved from the captured image; and
performing additional verification steps based on the information retrieved from the workspace scheduling server.

7. The method of claim 6, wherein when the bezel cover is in the visible mode, the transmission of visible light is enabled allow a user interacting with the conferencing device to determine that the three-dimensional authentication object is visible.

8. The method of claim 6, wherein the form authentication token is retrieved by an application installed on a mobile user device and utilizes the form authentication token associated with said mobile user device.

9. The method of claim 6, wherein the bezel cover further comprises a layer of electrochromic film that become opaque when de-energized and transparent when energized.

10. The method of claim 6, wherein when the bezel cover comprises a plurality of independently operable electrochromic shutters arranged over several LIDAR readable three-dimensional objects.

11. A workspace management system comprising:
A mobile user device;
A remote cloud server communicatively coupled with said mobile user device, said remote cloud server adapted to interface with one or more electronically controlled devices disposed in a workspace; and
An authentication engine, stored in a nonvolatile storage and communicatively coupled with the remote cloud server over a cloud network, said authentication engine being adapted to receive input data from the mobile user device comprising a three-dimensional data object including physical parameters by which a user is authenticated.

12. The workspace management system of claim 11, wherein said three-dimensional data object is captured by a camera of said mobile user device.

13. The workspace management system of claim 11, wherein said three-dimensional data object includes biometric characteristics of a user.

14. The workspace management system of claim 11, further comprising a database, wherein said authentication engine is adapted to compare said input data with stored biometric information of said user.

15. The workspace management system of claim 11, wherein said three-dimensional data object includes facial recognition patterns associated with a user.

16. The workspace management system of claim 11, further comprising a control system processor adapted to act as an intermediary between said remotely cloud server and the electronically controlled devices.

17. The workspace management system of claim 11, wherein said remotely cloud server is adapted to receive data directly from the electronically controlled devices.

18. The workspace management system of claim 11, wherein said workspace management system is customized according to user requirements.

19. A method for multifactor authentication using a three-dimensional data object, said method comprising:
Receiving input data from a mobile user device, said input data comprising a three-dimensional data object including physical parameters by which a user can be authenticated;
Transmitting said input data from said mobile user device to a remote cloud server over a cloud network;
Comparing said input data received from said mobile user device with stored biometric information associated with said user; and
Authenticating said user if said input data matches said stored biometric information.

20. The method of claim 19, wherein said three-dimensional data object is captured by a camera of said mobile user device.

21. The method of claim 20, wherein said three-dimensional data object includes biometric characteristics of a user.

22. The method of claim 19, wherein said input data is transmitted by said mobile user device via a Uniform Resource Locator (URL) decoded from a QR-Code.

23. The method of claim 19, further comprising controlling one or more electronically controlled devices disposed in a workspace based on the authentication of said user.

24. A workspace management system comprising:
a remote cloud server comprising a CPU, a main memory and a nonvolatile storage;
the nonvolatile storage comprising workspace automation application;
a plurality of controllable electronic devices associated with said workspace management system;
one or more mobile user devices adapted to access said remote cloud server; and
an authentication engine operably associated with said main memory and said CPU, wherein said authentication engine is adapted to authenticate users using said mobile user device.

25. The system as claimed in claim 24, further comprising control system processor connected to said electronic devices; and
wherein said control system processor comprises web interface to communicate with said remote cloud server.

26. The system as claimed in claim 24, wherein said authentication engine stores data and logic steps necessary to authenticate users using said mobile user device.

27. The system as claimed in claim 24, wherein said authentication engine comprises multifactor authentication capabilities, which comprise Three-dimensional data objects for various authentications.
